(19) United States
(12) Patent Application Publication
(10) Pub. No.: US 2013/0333627 A1
(43) Pub. Date: Dec. 19, 2013

(54) Temperature-Controllable Aquaculture Apparatus

(71) Applicant: Naomi POHL, Morristown, NJ (US)

(72) Inventor: Naomi POHL, Morristown, NJ (US)

(73) Assignee: Naomi POHL, Morristown, NJ (US)

(21) Appl. No.: 13/969,802

(22) Filed: Aug. 19, 2013

(51) Int. Cl. A01K 63/00

(52) U.S. Cl. CPC A01K 63/006
USPC 119/263

(57) ABSTRACT

An inexpensive, easily manufactured aquaculture apparatus featuring a water temperature control feature, useful for studying the effect of water temperature changes on the viability of aquatic species. The apparatus is useful to, for example, study the potential effect of global warming and rising ocean water temperatures on various aquatic species.

### RELATED APPLICATIONS

None

### GOVERNMENT INTEREST

None

### BRIEF DESCRIPTION

Climate change, as evidenced by “global warming,” has been confirmed through multiple scientific studies. One study, conducted by Donna Ashizawa and Jonathan J. Cole, predicted, “Global temperatures may rise 3° C.±1.5° C., at the rate of 0.6°-0.80° C. per decade” (1994).ⁱ The European Environment Agency stated that global ocean water temperature has risen about 0.6° C. since 1870 due to climate change.ⁱⁱ Sea surface temperatures are typically found by models to increase by about 2.5° C. over each century of carbon dioxide doubling; results from a 1992 study show that Atlantic Ocean temperatures (at precise locations along a 24° N transatlantic section) at a depth of 1,100 meters increased at a rate of just about 1° C. per century.ⁱⁱⁱ Climate change is still being thoroughly investigated, but projected effects include rising water levels, melting ice caps, altered wildlife populations, changing disease patterns, and more severe and frequent extreme weather conditions.^{iv}

Rising ocean temperature impacts weather, and may also impact biodiversity. This is because warmer water holds less oxygen. Low oxygen levels combined with higher carbon dioxide levels may cause some species' oxygen transport mechanisms to bind with carbon dioxide in place of oxygen; this would invariably make it more difficult for the organism to breathe. Species that have “energy intensive” forms of swimming, such as squid, may find temperature rise particularly detrimental for this reason.^{iv} Further, even species without energy-intensive swimming (e.g., mollusks) may have an impaired ability to thrive in warmer water. Thus, it would be advantageous to have an inexpensive aquaculture apparatus that provides the ability to control and adjust water temperature.

Until now, however, scientists have not had an inexpensive aquaculture apparatus to grow aquatic organisms and simulate the effects of water temperature change on organisms that may be affected by this change. I have designed, built, and tested such an apparatus. My test results confirm that this apparatus works well to provide an inexpensive apparatus to assess the impact of changes in water temperature on the growth of aquatic species.

### BRIEF DESCRIPTION OF THE DRAWINGS

FIG. 1 provides an overview of one version of my apparatus.

### DETAILED DESCRIPTION

Materials and Methods

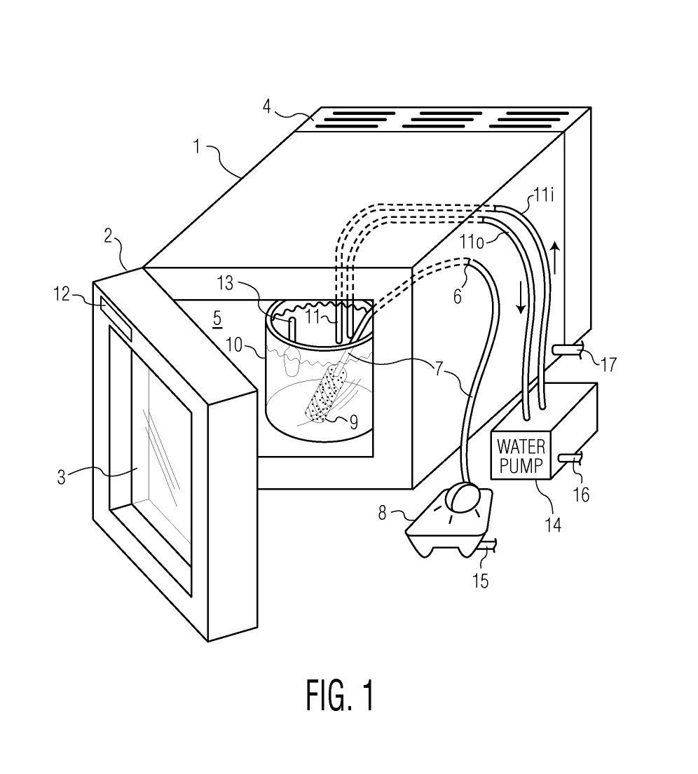

I illustrate an embodiment of a suitable apparatus in FIG. 1. Referring to the numbered elements in FIG. 1, element [1] is a refrigeration device. In my temperature stability test described below, I used a DANBY® MAITRE'D® 6-bottle thermoelectric wine cooler, commercially available from Danby Products, Inc., Findlay, Ohio, which operates at a temperature range of 39° F.-72° F. It is 11″ in width, 22″ in depth, and 17″ in height.

The device [1] includes a door mechanism [2] that is used to open the refrigeration device to access its interior. Tight-fitting seals on 3 sides of the doorframe retain all cooling power and humidity levels. The door mechanism [2] includes a translucent glass front [3]. It is tinted for UV protection but also allows for easy interior viewing.

The device [1] includes a refrigerating mechanism [4] that cools the interior of the wine cooler. The refrigeration mechanism must be chosen carefully, because my invention requires air to be continuously pumped into the interior space [5] of the refrigeration device. This air warms the interior space [5] of the refrigeration unit, and thus must be cooled to the desired temperature. Thus, to maintain the desired temperature, the refrigeration mechanism must have sufficient cooling capacity to compensate for the constant addition of warm air. The entire device is plugged into an outlet via a power cord [17].

The device [1] includes an interior space [5] where the aquaculture tanks and air diffusers are located. The device [1] also includes a hole or port [6] through which airline tubing [7] passes from the exterior of the refrigeration device [1] to the interior space [5]. This hole [6] allows the airline tubing [7] to pass through the side of the refrigeration device [1] rather than through the front door [2] of the refrigeration device [1], thereby increasing the amount of air that is retained in the device and minimizing heat loss via the door. In a preferred embodiment, one may create a port [6] through the side of the refrigeration device [1] using a power drill and a 3/16″ drill bit, sized to assure a snug fit for the airline tubing [7]. In a preferred embodiment, the airline tubing [7] is a 2.5′ length piece of LEE'S® standard clear plastic 3/16″-diameter flexible airline tubing for aquariums, commercially available from Lee's Aquarium and Pet Products, San Marcos, Calif.

The exterior section of the airline tubing [7] is attached to a JW PET COMPANY® Fusion Air Pump 400 [8], commercially available from JW Pet Company, Inc., Arlington, Tex., which is located outside of the refrigeration device [1]. The air pump is also plugged into an outlet via a power cord [15]. The interior section of the airline tubing [7] is attached to a 2.5″ tall, 1.5″ diameter aquarium air diffuser [9], which receives airflow from the air pump [8] and converts it into air bubbles to oxygenate the aquaculture water.

The air diffuser [9] is placed inside an aquaculture container [10] in the interior space [5] that holds both the aquaculture water and the aquaculture organisms. In order to keep the aquaculture water clean, a fluid exchange pipe [11₀] may optionally be used to draw dirty water from the aquaculture container [10], via a water pump [14], and another fluid exchange pipe [11,] may optionally be used to bring clean aquaculture water into the container. The water pump [14] is plugged into an outlet via a power cord [16].

In order to view and regulate the interior temperature of the refrigeration device [1], an electronic display and control panel [12] is located on the front of the door mechanism [2]. The display and control panel includes a temperature adjustment switch to regulate the refrigeration mechanism [4]. This switch may comprise a temperature ‘UP’ button (used to raise the interior refrigeration device temperature, e.g., in 1° increments), and a temperature ‘DOWN’ button (used to decrease the interior refrigeration device temperature e.g., in 1° increments). The control panel [12] may optionally include additional features such as a power button, a temperature display screen (shows the current temperature setting) or an interior light toggle button (used to manually illuminate or extinguish the interior lights while the door remains closed).

A glass thermometer and hydrometer [13] is placed in the aquaculture container [10] in the water, to show both the actual water temperature and water salinity level (in parts per thousand) simultaneously, since the temperature displayed on the display and control panel [12] measures the ambient air temperature in the interior space [5] and does not always precisely match the actual temperature of the aquaculture water.

Note that in the embodiment illustrated, the air pump is placed on the outside of the refrigeration device. As an alternative, the pump may be placed in the interior space [5] of the refrigeration device. These alternatives each present certain advantages and disadvantages.

Placing the air pump in the interior space [5] of the refrigeration device means that electric power must be supplied to the interior space [5]. This may readily be done by, for example, installing an electric power outlet on the interior surface of the refrigeration device [1]. Alternatively, the air pump power cord [16] can be passed through the hole [6] in the refrigeration device [1]. Placing the air pump in the interior space [5] of the refrigeration device means the air in the refrigeration device re-circulates repeatedly through the aquaculture containers [10]. This may be advantageous if the organisms present a biohazard. This also eases water temperature control, because the air fed into the aquaculture containers [10] is the same temperature as the ambient air in the interior space [5] of the refrigeration device [1]. Recirculation of air, however, means that the organisms will gradually deplete the oxygen in the air. Thus, if the pump is placed in the interior space [5], one would need to monitor O₂ and CO₂ levels in the interior space [5] and add supplemental oxygen as needed.

Placing the air pump exterior to the refrigeration device (as illustrated in FIG. 1) enables the pump to pump air directly from the surrounding environment into the refrigeration device interior, and thence into the water in the aquaculture containers. This placement is advantageous because it assures the aquaculture water will be adequately oxygenated with new oxygen, to thereby provide a suitably-oxygenated growth medium for the species there grown. This pump configuration, however, poses two demands on the system.

First, the pump must be sited in a location which itself has adequate oxygen for aquaculture. For most purposes, location in a room with free air circulation is adequate.

Second, placing the pump exterior to the refrigeration device [1] means that the system must be tuned to assure that it is able to maintain a constant water temperature. This is because the air pump [8] constantly adds to the interior space [5] air which is drawn from outside the refrigeration device [1]. That air is most likely at a temperature different from—and perhaps markedly different from—the temperature desired for the interior space [5]. Thus, the refrigeration mechanism [4] must be selected carefully to assure that it is adequately powered to cool the incoming air, and do so quickly enough to maintain the temperature of the water in the aquaculture container [10]. This calculation requires considering the volume of water in the aquaculture container [10], the oxygen consumption rate of the animals in that container, the air flow required to replace that oxygen, and the amount of heat per unit time that air introduces into the system (itself a function of the difference in temperature between the external air and the internal space [5]). Incorrectly tuning the system may result in a system which cannot achieve the desired temperature, or which cycles between the desired temperature and the ambient air temperature.

### EXAMPLE 1

Four DANBY® MAITRE'D® wine coolers were used to make the apparatus depicted in FIG. 1. They were labeled (“A” through “D,” respectively). A nominal interior temperature for the interior space [5] was set using the temperature control panel [12].

Four 1-gallon polyethylene plastic containers were obtained; in each was placed thirty two (32) ounces of room temperature water. One such plastic container with water was then placed into each of the wine coolers (A-D). The ambient room air temperature was measured. The door [3] was then closed, and the system allowed to temperature stabilize for twelve hours.

After twelve hours, temperature measurements were taken using a digital thermometer of the ambient room air temperature, the interior space [5] air temperature and the water temperature. Results are shown in Table 1. The first Column shows the label of the cooler. The next Column shows the nominal temperature, i.e., the temperature set using the temperature control panel [12] on the refrigerator apparatus [1]. The next Column shows the actual air temperature of the air in the interior space [5], as measured by a digital thermometer after the 12-hour stabilization period. The next Column shows the difference (in degrees Fahrenheit) between the nominal temperature and the actual air temperature. The next Column shows the water temperature for the water stored in the cooler, as measured by a digital thermometer after a 12-hour period. The next Column shows the difference between the nominal temperature set by the temperature control panel [12] and the actual water temperature achieved after twelve hours. The next Column shows the difference (in percent) between the nominal temperature and the actual water temperature observed after 12 hours. The final Column shows the difference (in percent) between the actual water temperature and the actual air temperature at 12 hours.

TABLE 1

| | | | | Water | | | |
|---|---|---|---|---|---|---|---|
| | Air | | | | | Variance | Water |
| | | | Variance | | Variance | From | variance |
| | Nominal | Air | From | Water | From | Nominal | From Air |
| Chiller | Temp | Temp | Nominal | Temp | Nominal | (%) | (%) |
| A | 50 | 53.9 | 3.9 | 52.7 | 2.7 | 5.4% | 2.2% |
| B | 55 | 60.8 | 5.8 | 59.0 | 4.0 | 7.2% | 3.0% |
| C | 60 | 64.9 | 4.9 | 63.6 | 3.6 | 6.0% | 2.0% |
| D | 65 | 65.3 | 0.3 | 64.5 | 0.5 | 0.8% | 1.2% |

Temperatures are in degrees Fahrenheit. The ambient room air temperature was 65° F. at both commencement and after twelve hours.

The above experimental protocol was repeated, producing the results shown in Table 2.

TABLE 2

| | | | | Water | | | |
|---|---|---|---|---|---|---|---|
| | Air | | | | | Variance | Water |
| | | | Variance | | Variance | From | variance |
| | Nominal | Air | From | Water | From | Nominal | From Air |
| Chiller | Temp | Temp | Nominal | Temp | Nominal | (%) | (%) |
| A | 50 | 50.1 | 0.1 | 52.1 | 2.1 | 4.2% | 4.0% |
| B | 55 | 58.6 | 3.6 | 59.0 | 4.0 | 7.2% | 0.7% |
| C | 60 | 63.8 | 3.8 | 64.0 | 4.0 | 6.7% | 0.3% |
| D | 65 | 64.9 | 0.1 | 66.0 | 1.0 | 1.5% | 1.7% |

Temperatures are in degrees Fahrenheit. The ambient room air temperature was 65° F. at both commencement and after twelve hours.

These data provide insight into whether a device as simple as a conventional wine chiller can feasibly be used for controlling aquaculture temperature.

One insight is that the particular wine chillers used, despite having a temperature-control panel [12], do not in fact control temperature particularly precisely. This insight can be derived from the fact that air has a far smaller heat capacity than does water; that is, for a given change in energy, air changes temperature much more rapidly than does water. If the temperature inside the unit [5] varies rapidly, then the air will equilibrate to this new temperature far more rapidly than does the water, thus creating a difference in temperature between air and water. The greater the difference between air temperature and the water temperature, the more rapid and more pronounced the change in appurtenant change in inside air temperature.

The data show that the temperature-control panel provides a reasonably accurate measure of temperature. For example, Unit D was set to provide a nominal temperature equal to ambient room air temperature (i.e., 65° F.). After two twelve-hour stabilizations, the actual interior air temperature was 64.5° and 66.0° F.; not exactly the nominal temperature, but, on average, accurate enough to support aquaculture work.

The data here also show that this system produces some inherent cycling of interior air temperature. This can be seen from Unit D, where the temperature of the ambient room air was the same as the desired nominal temperature of the water (i.e., 65° F.). This meant that the air pump provided a constant supply of fresh 65° F. ambient room air into the refrigerator interior [5]. One would expect this to potentially stabilize the temperature entirely, obviating the need for the refrigeration apparatus [4] to perform any thermal work. My actual results, however, did not bear this thesis out. Rather, in both trials, the temperature of the air in the interior space [5] for Unit D differed from the temperature of the water in the container [10], indicating the system had some amount of temperature cycling.

The data here show that the greater the difference between the nominal temperature and the outside air temperature, the greater the degree of temperature cycling. This is shown by the results for Units A-C, in comparing the inside air temperature and the water temperature. These data indicate that the greater the difference between the outside air temperature and nominal temperature, the greater the change in inside air temperature over time, and the more rapid those temperature changes occur.

These results suggests that to assure a relatively constant water temperature, one needs to use a large enough volume of water in the aquaculture container so that the water can act as a heat sink, providing a great enough heat capacity to resist temperature change in response to transient changes in inside air temperature. The 32 ounce water volume used here was adequate for this only when the nominal temperature was within perhaps 5° F. of the ambient room air temperature. Extrapolating from this, I believe using a full gallon of water (as would be necessary to provide adequate oxygen to support even a small number of animals) would provide quite stable water temperature.

Overall, the apparatus proves a viable yet inexpensive way to control water temperatures in an experimental environment. While the actual water temperature often varies from the desired water temperature, after a few preliminary tests, these variabilities can be controlled for.

ⁱ Ashizawa, D., & Cole, J. J. (1994, March). Long-term temperature trends of the Hudson River: A study of the historical data. Estuaries, 17(1, Part B), 166-171. Retrieved from http://www.jstor.org//

ⁱⁱ Rising sea surface temperature: Towards ice free Arctic summers and a changing marine food chain. (2011, Apr. 13). Retrieved Jan. 3, 2012, from European Environment Agency website: http://www.eea.europa.eu/themes/coast_sea/sea-surface-temperature

ⁱⁱⁱ Parrilla, G., Lavin, A., Bryden, H., Garcia, M., & Millard, R. (1994). Rising temperatures in the subtropical north Atlantic Ocean over the past 35 years. Nature, 369, 48-51. doi:10.1038/369048a

^{iv} Harrould-Kolieb, E., & Savitz, J. (2009, June). Acid test: Can we save our oceans from CO2? (Research Report). Oceana.

I claim:

1. A temperature-controllable aquaculture aquarium apparatus comprising:
a. a refrigerator device having a plurality of walls defining an interior space, said refrigerator device having a door to isolate said interior space from space exterior to the refrigerator device;
b. an aquaculture container disposed in the interior space of the refrigerator device, said aquaculture container defining a space able to contain water, said space able to contain water having a thermometer and an air diffuser disposed therein;
c. Said air diffuser connected to an air hose connected to an air pump.

2. The apparatus of claim 1, wherein said air pump is disposed in said interior space of said refrigerator device.

3. The apparatus of claim 1, wherein said air pump is disposed exterior to said refrigerator device, wherein said refrigerator device has a port, and wherein said air hose passes from said air diffuser through said port to the exterior of said refrigerator device to connect to said air pump.

4. The apparatus of claim 1, further comprising a water intake pipe and a water outflow pipe, each pipe having an interior end and an exterior end, the interior end of each pipe disposed in the aquaculture container space able to contain water, each pipe passing through a hole in a wall of the refrigerator device and to the exterior of the refrigerator device, the exterior end of each pipe connected to a water pump disposed exterior to said refrigeration device.

5. In an aquaculture aquarium defining a space able to contain water, and having air diffuser disposed in said space able to contain water and connected to an air hose connected to an air pump, the improvement comprising:
a. a refrigerator device having a plurality of walls defining an interior space large enough to accommodate said aquaculture aquarium, said refrigerator device having a door to isolate said interior space from space exterior to the refrigerator device;
b. said aquaculture aquarium disposed in the interior space of the refrigerator device.

6. The apparatus of claim 5, wherein said air pump is disposed in said interior space of said refrigerator device.

7. The apparatus of claim 5, wherein said air pump is disposed exterior to said refrigerator device, wherein said refrigerator device has a port, and wherein said air hose passes from said air diffuser through said port to the exterior of said refrigerator device to connect to said air pump.

8. The apparatus of claim 5, further comprising a water intake pipe and a water outflow pipe, each pipe having an interior end and an exterior end, the interior end of each pipe disposed in the aquaculture aquarium space able to contain water, each pipe passing through a hole in a wall of the refrigerator device and to the exterior of the refrigerator device, the exterior end of each pipe connected to a water pump disposed exterior to said refrigeration device.

9. A method for temperature-controlled aquaculture comprising:
a. providing the apparatus of claim 1, and
b. culturing in said aquaculture container at least one aquatic species.
